(19) United States
(12) Patent Application Publication
(10) Pub. No.: US 2026/0359645 A1
(43) Pub. Date: Nov. 12, 2026

(54) LOCALLY ADAPTIVE ANOMALY DETECTION

(71) Applicant: NEC Laboratories America, Inc., Princeton, NJ (US)

(72) Inventors: Shaobo HAN, Princeton, NJ (US); Ming-Fang HUANG, Princeton, NJ (US); TingFeng LI, Princeton, NJ (US)

(73) Assignee: NEC Laboratories America, Inc., Princeton, NJ (US)

(21) Appl. No.: 19/671,048

(22) Filed: May 7, 2026

Related U.S. Application Data
(60) Provisional application No. 63/802,885, filed on May 9, 2025.
(60) Provisional application No. 63/969,214, filed on Jan. 27, 2026.

(51) Int. Cl. G06N 3/088; G06F 11/27

(52) U.S. Cl. CPC G06N 3/088; G06F 11/27

(57) ABSTRACT

A system and method for locally adaptive anomaly detection (LAAD) in fiber optic sensing are provided. The method includes dividing a fiber optic route into segments and collecting unlabeled ambient data to perform a self-supervised pre-text task. In the pre-text task, a model predicts the location index of data patches to extract domain-specific features. These features are then used to train or fine-tune a model for downstream classification tasks. During inference, the system compares a predicted location index to a known ground truth location. A discrepancy between the predicted and actual location identifies an anomaly. The framework utilizes a projection head to resolve learning conflicts and supports ensemble learning to improve robustness. This approach reduces data labeling requirements and allows for automated, location-specific AI calibration on new fiber deployments.

### CROSS REFERENCE TO RELATED APPLICATIONS

This application claims the benefit of U.S. Provisional Patent Application Ser. No. 63/802,885 filed May 9, 2025, and 63/969,214 filed Jan. 27, 2026, the entire contents of each of which is incorporated by reference as if set forth at length herein.

### FIELD OF THE INVENTION

This application relates generally to distributed fiber optic sensing (DFOS) systems, methods, and structures. More particularly, it pertains to improved system and method for locally adaptive anomaly detection (LAAD) using self-supervised learning and unsupervised feature extraction.

### BACKGROUND OF THE INVENTION

As those skilled in the art will understand and appreciate, Distributed Fiber Optic Sensing (DFOS) technology, including Distributed Vibration Sensing (DVS) and Distributed Acoustic Sensing (DAS), utilizes optical fiber as a sensing medium to measure environmental phenomena such as vibration and acoustic signals. However, existing AI solutions often over-fit to specific fiber routes. Adapting these models to new routes typically requires significant manual effort, including extensive data annotation, model re-training, and parameter tweaking. Furthermore, different cable depths, mounting configurations (e.g., aerial vs. buried), and sensor types create a “domain gap” that makes generalizable AI difficult to scale across vertical domains

### SUMMARY OF THE INVENTION

An advance in the art is made according to aspects of the present disclosure directed to a locally adaptive anomaly detection (LAAD) framework that allows for the self-calibration of AI on new fiber routes using unlabeled data. The framework utilizes a two-stage training process: an unsupervised self-training stage where a model learns to predict location indices based on the intrinsic non-stationary structure of DFOS data, followed by a supervised training or fine-tuning stage for specific downstream tasks. By comparing a predicted location index to a known ground truth location during inference, the system provides conditional, location-specific anomaly detection.

Viewed from a first aspect, we describe a locally adaptive anomaly detection (LAAD), a new framework which allows self-calibration of AI on new routes, based on unlabeled data. The framework is based on self-supervised learning and unsupervised feature extraction based on nonlinear independent component analysis (ICA). Our inventive method shares the same identifiability guarantees with time-constrastive learning (TCL), yet in sharp contrast, we utilize the location nonstationary structure of fiber-optic sensing data.

Design choices of dividing cable routes into different segments and use location index as pre-text task considers the intrinsic “linear sensing” nature of DFOS. Moreover, it cast a common paradigm of representation learning that is agnostic to downstream tasks (such as cable cut event classification, manhole localization, intrusion detection, traffic accident detection, etc.). As a result, our inventive solution can benefit a multitude of fiber sensing use cases

Before training, the burden of data labeling can be reduced significantly—i.e., by orders of magnitude-using our inventive method to screen out a high proportion of “normal” images. After deployment, our method can advantageously be used for locally-adaptive and conditional anomaly detection by comparing each location to its own history.

Finally, as we shall show and describe, our inventive framework and method provide a number of particularly inventive aspects such as those listed below.

### Locally Adaptive Via Location Prediction

We studied the feasibility of predicting location index based on a small waterfall snapshot (of a short time duration and cable segment). Our inventive method can effectively distinguish the location with high accuracy.

### Resolve Conflicts Between Different Learning Objectives

Our inventive method provides a good alignment between pre-task task and downstream classification task based on high-dimensional embedding before a projection head. As a result, data labeled from different routes can be reused by evaluating similarity under the learned domain-specific representation.

### Automated Through Computation

If an optical cable is cut (and repaired), cable length may change, and location-specific models need re-training. According to an aspect of the present disclosure, such re-training processes can be conducted relatively easily, since it does not require human intervention or additional data annotation.

### Conditional and Location-Specific Anomaly Detection

Based on a representation learned in the pre-text task, conditional anomaly detection can be conducted. Anomaly examples can be unseen during training, and the definition is conditional on the characteristics of patches seen previously at the same location.

### Use for Cost-Effective Data Annotation

Advantageously, our inventive approach can also be used for reducing the burden of data annotation before conducting machine learning training. It can help decide which small portion of the data needs further human examination.

### Task-Agnostic and Generically Applicable

Our method can be used in many DFOS use cases, as a common procedure to extract feature in an unsupervised way and thereby enhance label efficiency and bridge domain gaps.

### BRIEF DESCRIPTION OF THE DRAWING

FIG. 1(A) and FIG. 1(B) are schematic diagrams showing an illustrative prior art uncoded and coded DFOS systems.

FIG. 2(A) is a schematic diagram showing illustrative prior art approach to training one domain-invariant model based on common representations of features.

FIG. 2(B) is a schematic diagram illustratively showing our inventive approach which advantageously trains a family of domain-specific models, one for each domain, based on a common dataset for downstream task (supervised training), and the unlabled dataset from each domain (unsupervised self-training), according to aspects of the present disclosure.

FIG. 3(A) is a schematic diagram illustratively showing our inventive locally adaptive anomaly detector according to aspects of the present disclosure.

FIG. 3(B) is a schematic diagram illustratively showing history patches from a location A using our inventive locally adaptive anomaly detector according to aspects of the present disclosure.

FIG. 4 is a schematic diagram illustratively showing a processing pipeline for unsupervised self-training according to aspects of the present disclosure.

FIG. 5 is a schematic diagram illustrating data visualization of features extracted after the unsupervised self-training according to aspects of the present disclosure.

FIG. 6 is a schematic diagram illustratively showing a processing pipeline for supervised training or fine-tuning according to aspects of the present invention.

FIG. 7 is a schematic diagram illustrating data visualization on features extracted after a supervised training step according to aspects of the present disclosure.

FIG. 8 is a schematic diagram illustratively showing a processing pipeline for model inference after deployment according to aspects of the present disclosure.

FIG. 9 shows an illustrative dataset used to conduct in-depth ablation studies on the model design according to aspects of the present disclosure.

FIG. 10 shows an illustrative alignment of representation and empirical effectiveness of the M-2 projection head according to aspects of the present disclosure.

FIG. 11 shows an illustrative dataset used to conduct in-depth ablation studies on the model design according to aspects of the present disclosure.

FIG. 12 is a schematic block diagram showing an illustrative computing platform on which operational aspects of the present disclosure may be executed according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

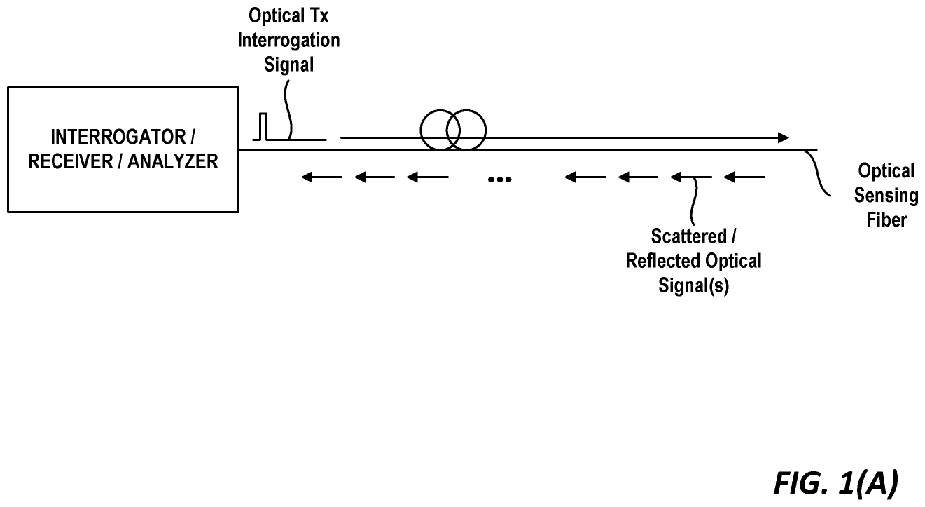

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

Distributed Temperature Sensing (DTS) is a technology that utilizes optical fibers as linear sensors to measure temperature continuously along their length. Instead of using discrete temperature sensors at specific points, a DTS system provides a temperature profile over the entire fiber, which can extend for many kilometers.

DTS technology primarily relies on the interaction of light with the glass structure of the optical fiber, specifically a phenomenon called Raman scattering. When a short pulse of laser light is sent into the fiber, a small portion of the light is scattered back in different wavelengths. This backscattered light contains information about the temperature at the point of scattering.

As previously noted, there are three main types of scattering, but DTS systems mainly analyze Raman scattering:
Rayleigh Scattering: Light scattered back at the same wavelength as the incident light. This is used in Optical Time Domain Reflectometry (OTDR) for locating faults in fibers but not primarily for temperature sensing in DTS.
Brillouin Scattering: Light scattered back with a slight frequency shift that is sensitive to both temperature and strain. Some DTS systems use Brillouin scattering, but careful design is needed to differentiate between temperature and strain effects.
Raman Scattering: Light scattered back at different wavelengths (Stokes and anti-Stokes lines). The intensity ratio between the anti-Stokes and Stokes lines is directly dependent on the temperature at the scattering point. The anti-Stokes line is more temperature sensitive.

As previously noted, Distributed Fiber Optic Sensing (DFOS) technology utilizes optical fiber as a sensing medium to measure various environmental phenomena, including temperature, strain, vibration, and acoustic signals. Among its applications, Distributed Acoustic Sensing (DAS) leverages Rayleigh backscattering for acoustic and vibration detection, and leverages AI/machine learning algorithms for event or status recognition. With the increasing deployment of DAS systems of different types (pulse mode or coded mode), configuration (with or without Raman amplifier), into different cable routes (in different countries, cities, buried depths), cable mounting (buried, aerial, indoor), and stepping into different vertical domains (e.g., telecom, power & utilities, government), a scalable solution of AI adaptation is needed.

More specifically, the goal is to develop generalizable AI under limited resources (labeled training data, computation, developer hours) that could adjust itself in new deployment environments or data acquisition conditions and therefore reduce the deployment cost of Fiber Optics Smart Sensing (FOSS)-AI systems.

To build scalable software systems for such applications, it is of interest to have an algorithmic solution having the following features: (1) scalable with data, which can leverage the large-scale unlabeled ambient data collected from DAS after connecting to a new route. (2) scalable with computation: performance improves with computation with less human intervention, and (3) scalable with deployment in the sense that labeled data across different routes can be reused, after appropriate normalization.

However, existing algorithmic solutions in fiber sensing usually over-fit to a single route where abundant labeled training data is available. Adaptation of such AI to a new route usually requires significant efforts, including data annotation, model re-training, and parameter tweaking.

As we have noted, we describe locally adaptive anomaly detection (LAAD), a new framework which allows self-calibration of AI on new routes, based on unlabeled data. The framework is based on self-supervised learning and unsupervised feature extraction based on nonlinear independent component analysis (ICA). Our inventive method shares the same identifiability guarantees with time-constrastive learning, and differently, we utilize the location nonstationary structure of fiber-optic sensing data.

The design choices of dividing cable routes into different segments and use location index as pre-text task takes into account the intrinsic “linear sensing” nature of DFOS. Moreover, it cast a common paradigm of representation learning that is agnostic to downstream tasks (such as cable cut event classification, manhole localization, intrusion detection, traffic accident detection, etc.). As a result, this solution can benefit a multitude of fiber sensing use cases.

Before training, the burden of data labeling can be reduced significantly by orders of magnitude by using our method to screen out high proportion of “normal” images. After deployment, our method can be used for locally-adaptive and conditional anomaly detection by comparing each location to its own history.

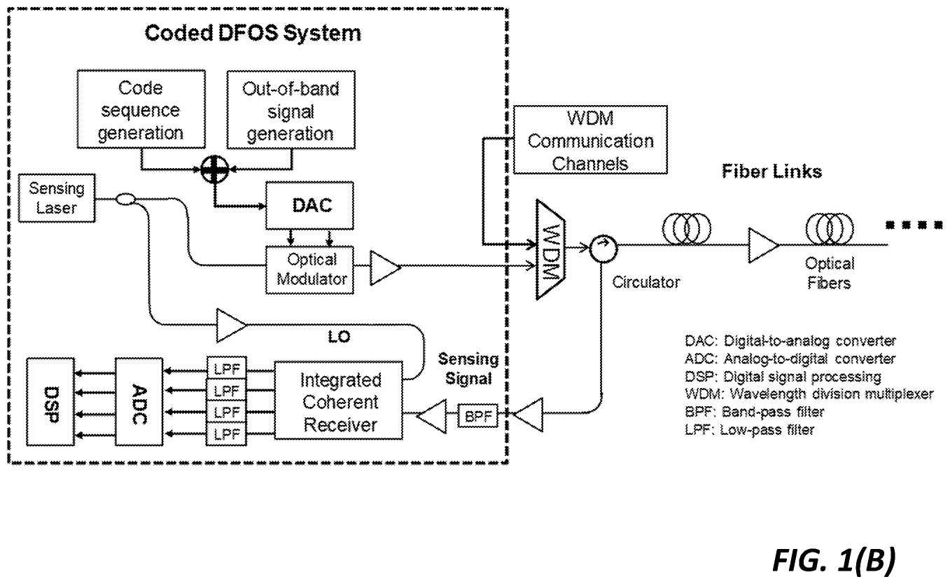

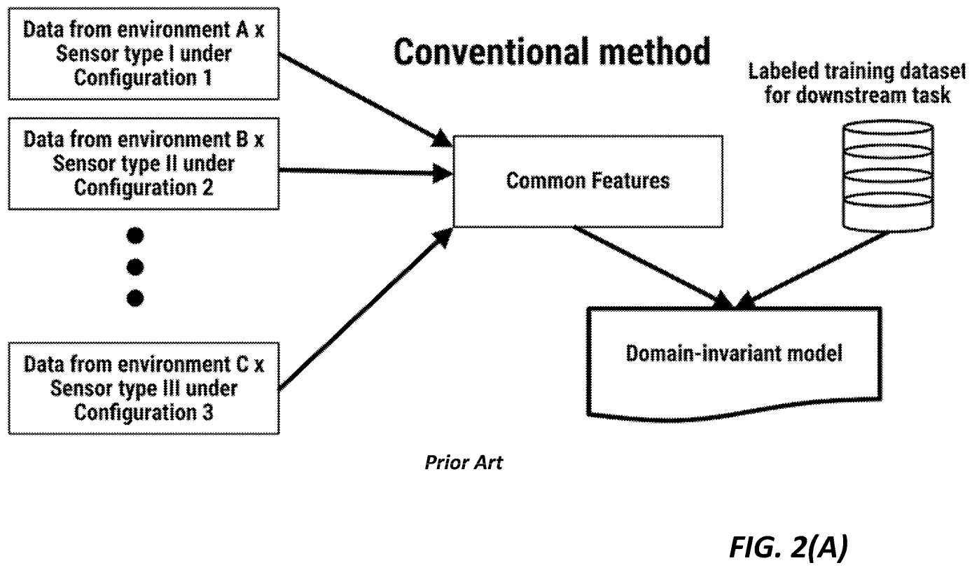

FIG. 2(A) is a schematic diagram showing illustrative prior art approach to training one domain-invariant model based on common representations of features.

With reference to that figure, we note that the generalization ability of the domain-invariant model strongly dependents on the size of the labeled training data, which is expensive to collect. The trained model is domain-invariant in the sense that it needs to achieve two tasks simultaneously, (1) implicitly differentiate data collected under different conditions, and (2) route it to different model branches to accommodate the heterogeneity. As a result, it has high requirement on the amount of labeled data from all routes, which is difficult to obtain at the same time.

FIG. 2(B) is a schematic diagram illustratively showing our inventive approach which advantageously trains a family of domain-specific models, one for each domain, based on a common dataset for downstream task (supervised training), and the unlabled dataset from each domain (unsupervised self-training), according to aspects of the present disclosure.

With reference to this figure, instead of training on domain-invariant model, our target is to train a family of domain-specific models, one for each domain, based on the common labeled dataset for downstream task (supervised training), and the unlabeled dataset from each domain (unsupervised self-training). The proposed locally adaptive model can learn a representation that is calibrated to the specific combination of {route x sensor x configuration}, and through this representation, a domain-specific model can be trained and assigned to the route explicitly. The advantage is that, the needs for internal routing is avoided. As a result, it has low requirement on the amount of labeled data. As the key component, representation learning is performed in the pre-text task with location index as label.

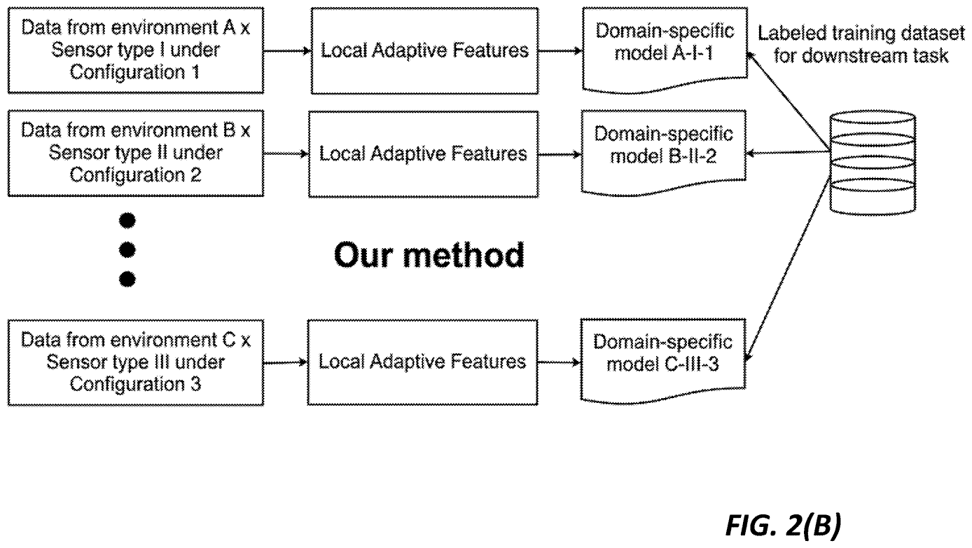

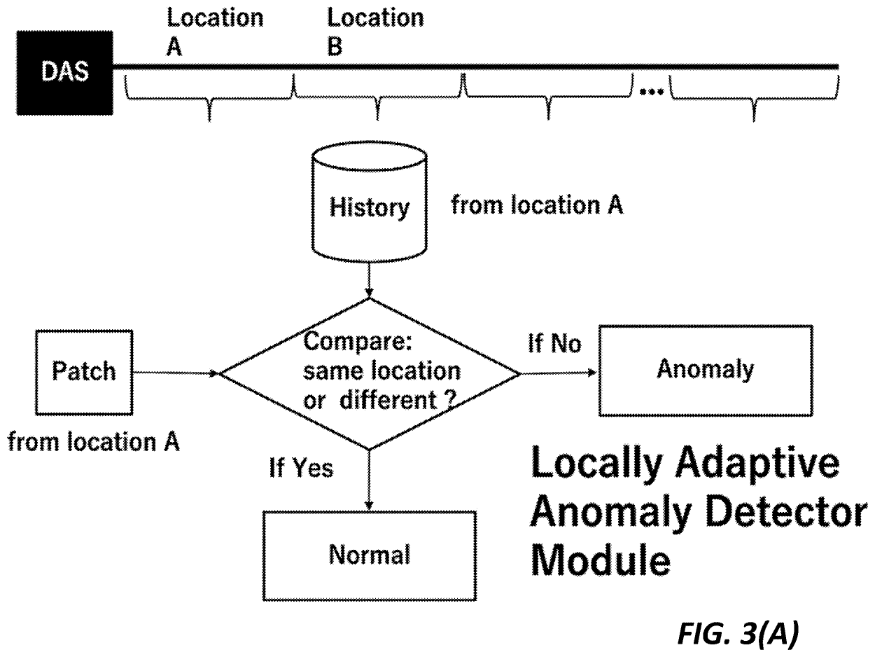

FIG. 3(A) is a schematic diagram illustratively showing our inventive locally adaptive anomaly detector according to aspects of the present disclosure.

FIG. 3(B) is a schematic diagram illustratively showing history patches from a location A using our inventive locally adaptive anomaly detector according to aspects of the present disclosure.

These figures illustrate the scheme of our inventive locally adaptive anomaly detection (LAAD) approach. The detected anomaly is conditional in a specific context of location, in reference to the vibration patterns commonly seen at the same location. The right panel shows an illustration. In distributed fiber-optic sensing, air conditioner, power generator, transformer, bridges, and pumps in manholes could all create strong vibrations with characteristic patterns. AI algorithms can recognize these patterns and decide whether it should be an anomaly or not. For example, a vertical continuous stride at manhole location are likely to be pumps inside, while at a non-manhole location, it could be the engine noise suggesting presence of machine

At this point, we note that our inventive locally adaptive anomaly detection (LAAD) approach can be separated into five steps as follows.

### Step 1—Data Acquisition

Connecting the DFOS interrogator (DAS, DVS, or DTS) to the cable and start collecting ambient data for the whole route.

### Step 2—Data Preparation

Divide the route into N segments, and assign the same class label to all the patches collected from the same cable segment. The width of the patch corresponds to the length of cable, and the height of the patch corresponds to the duration (typically about 1 minute). To avoid patches that do not contain any discriminative patterns, one should avoid using data from the time period during the late night when there are few traffic on the road. Measured data from different route tends to have different intensity values, we clamp at 0.95 quantile and set to integer values between [0, 255]. Finally, resize the patches into appropriate input size.

### Step 3—Unsupervised Self-Training

In the pre-text task, a deep neural network model is trained to predict location index based on patches. Design choices include model architecture (e.g., ResNet-18 or ResNet-34), loss function (e.g., cross-entropy loss), and embedding dimension. Besides of classification, one can also use the contrastive learning or competitive learning paradigms.

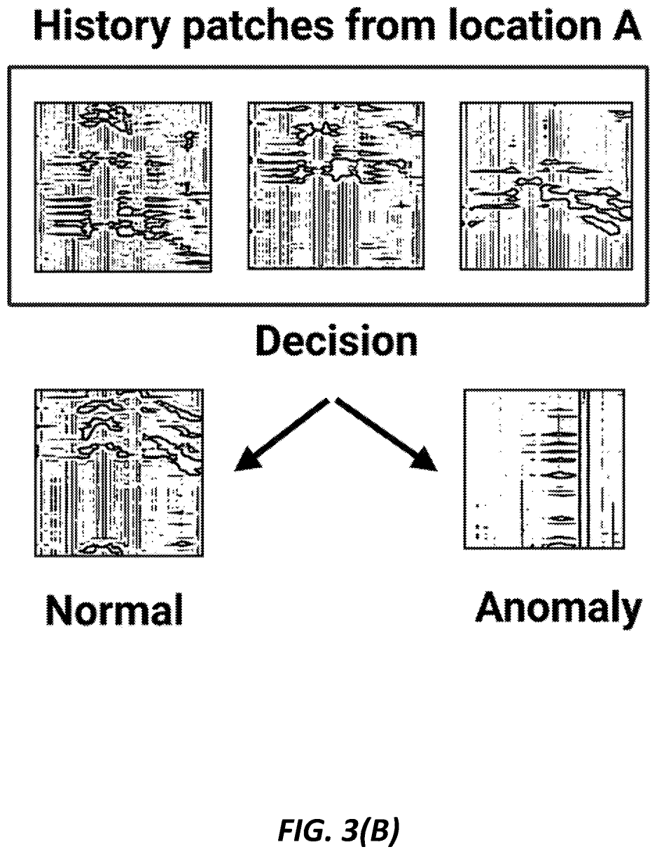

The model architecture of Step 2 and Step 3 is summarized in the flowchart in FIG. 4, with individual components explained in Table 1:

FIG. 4 is a schematic diagram illustratively showing a processing pipeline for unsupervised self-training according to aspects of the present disclosure.

TABLE 1
Detailed Components of the Unsupervised Self-training Step

Inputs:
I-1: DOFS ambient data from the whole route
I-5: Parameters related to data preparation (sliding window size, input size) and normalization
(value to [0, 255])
I-3: Ground truth location index, 0 to L, L is the number of locations
Procedures:
P-1: Turn waterfall images into patches, with the appropriate size and value range that can be
consumed by machine learning model
P-2: Model self-training based on the cross-entropy loss and backpropagation
Model components:
M-1: Locally adaptive encoder, the output of this module is the embedding we want to use for
downstream task
M-2: Projection head, an additional module maps high-dimensional embedding to the logits of
location prediction. The effectiveness of this module will be demonstrated in ablation study at the
end of this IR.
Outputs:
O-1: Predicted location index for each patch, to be compared to the ground truth that is readily
available

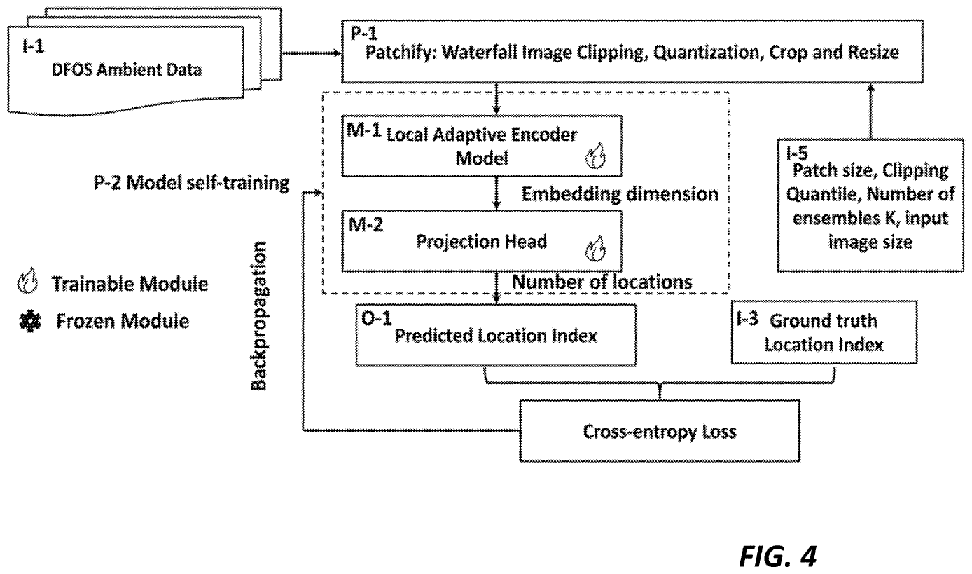

FIG. 5 is a schematic diagram illustrating data visualization of features extracted after the unsupervised self-training according to aspects of the present disclosure.

FIG. 5 shows the clustering and separation of the 32768-dim features extracted after the unsupervised self-training step. We first use principal component analysis (PCA) to project the feature into 10000 dim, and then use TSNE to map it to 2-dim. The specific symbol shown denote the classes from the downstream task. The model is trained using location as index, without using any labeled data from the downstream task of interest. As can be seen, the data instances from the same classes falls into isolated islands. This figure demonstrates the effectiveness of the location-based pre-text training. It is worth mentioning that the “machine_high” class and the “machine_idle” class are still overlapping with each other at this stage.

### Step 4—Supervised Training or Fine-Tuning

Training or fine-tuning a model for the downstream task, based on the learned representation in each domain in Step 3, and the labeled dataset (shared across all routes and conditions). The model is domain-specific and can be deployed to the corresponding environment.

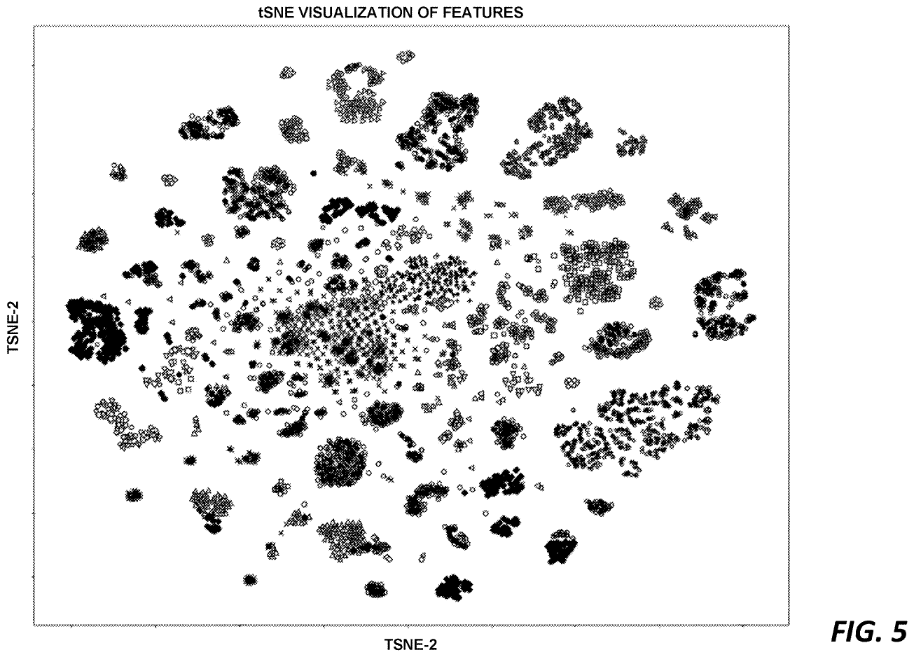

The model architecture of Step 4 is summarized in the FIG. 6, with individual components explained in Table 2:

FIG. 6 is a schematic diagram illustratively showing a processing pipeline for supervised training or fine-tuning according to aspects of the present invention.

TABLE 2
Detailed Components of the Supervised Training or fine-tuning Step

Inputs:
I-1: DOFS ambient data from the whole route
I-5: Parameters related to data preparation (sliding window size, input size) and normalization
(value to [0, 255])
I-4: Ground truth classification label, from the downstream task
Procedures:
P-1: Turn waterfall images into patches, with the appropriate size and value range that can be
consumed by machine learning model
P-3: Model training based on cross-entropy loss and backpropagation
Model components:
M-1: Locally adaptive encoder. Parameter frozen without updating.
M-3: Classification head, which maps high-dimensional embedding to the logits of class labels.
Outputs:
O-2: Predicted class labels for each patch, to be compared to the ground truth from expensive data
annotation and field confirmation.

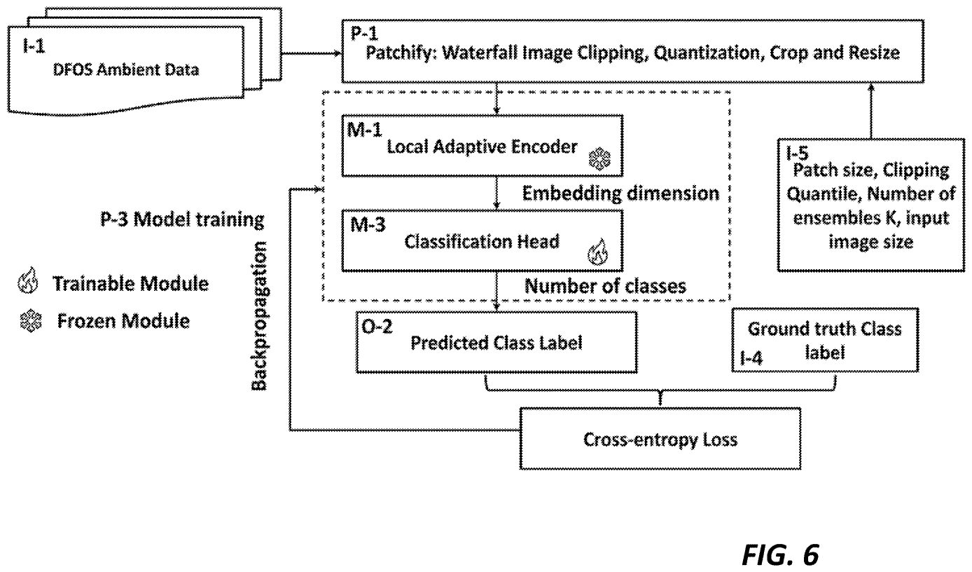

FIG. 7 is a schematic diagram illustrating data visualization on features extracted after a supervised training step according to aspects of the present disclosure.

FIG. 7 shows the clustering and separation of the 32768-dim features extracted after the supervised training step. Similarly, we first use principal component analysis (PCA) to project the feature into 10000 dim, and then use TSNE to map it to 2-dim. The model is trained using labeled data from the downstream task of interest (cable cut prevention anomaly classification). As can be seen, the data instances from the same classes falls into clusters with significant between-class margins, including the “machine_high” class and the “machine_idle” class.

### Step 5: Inference

After the two-stage model training detailed in Step 3 and Step 4, we have the whole model components of locally adaptive anomaly detection (LAAD) with trained weights to be used for (1) data annotation and (2) real-time inference. To further improve the robustness, one can choose to train K copies of the LAAD model and do ensemble learning via majority voting of the predicted labels. The decision process is as follows: if the predicted location index differs with the ground truth label that is easy to obtain from the sliding window division, they the corresponding patch should be either examined by a human annotator or feed into the classification module to obtain the predicted classification label.

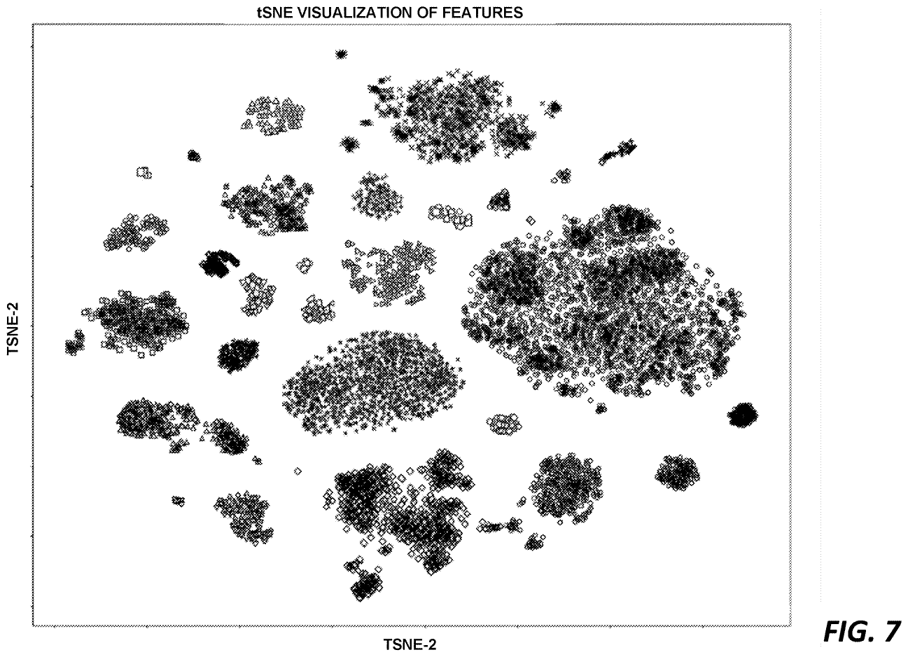

The model architecture of Step 5 is summarized in FIG. 8, with individual components explained in Table 3:

FIG. 8 is a schematic diagram illustratively showing a processing pipeline for model inference after deployment according to aspects of the present disclosure.

TABLE 3
Detailed Components of the Inference Step

Inputs:
I-2: DOFS data stream from the whole route
I-5: Parameters related to data preparation (sliding window size, input size) and normalization
(value to [0, 255]), K denoted the number of ensembles (odd number only)
I-3: Ground truth location index, 0 to L, L is the number of locations
Procedures:
P-1: Turn waterfall images into patches, with the appropriate size and value range that can be
consumed by machine learning model
P-4: Model inference fed the patches into the model to obtain predicted outputs (forward-pass
only)
P-5: Compare whether the predicted location is correct
Model components:
M-1: Locally adaptive encoder.
M-2: Projection head, which maps high-dimensional embedding to the logits of location labels.
M-3: Classification head, which maps high-dimensional embedding to the logits of class labels.
Outputs:
O-1: Predicted location index for each patch, after majority voting
O-2: Predicted class labels for each patch, to be compared to the ground truth from expensive data
annotation and field confirmation.
O-3: Anomaly patches to be examined by human annotator, with predicted class information for
alert reporting

In the following, we conducted further studies on the following four questions:
(i) Is it feasible to classify locations from DFOS data from whole routes?
(ii) Does the location-pretext task aligns well with the downstream classification?
(iii) Does the representation learned by LAAD supports cross-domain generalization?
(iv) How useful is LAAD for cost-effective data annotation?

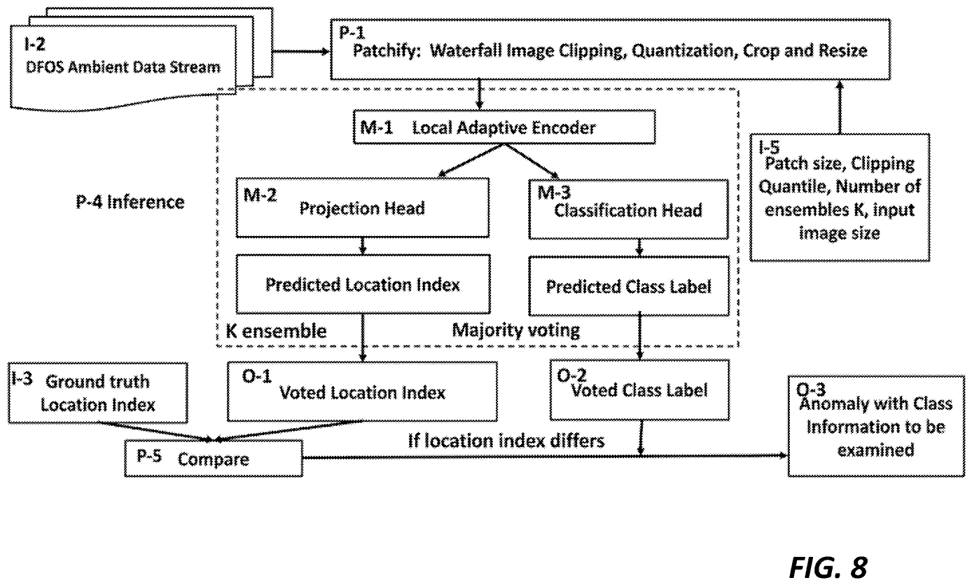

FIG. 9 shows an illustrative dataset used to conduct in-depth ablation studies on the model design according to aspects of the present disclosure.

In addition to FIG. 6, we provide additional quantitative evidence about the feasibility, alignment and visualize the learning process of self-training and examine whether they are learning conflicts during the late stage.

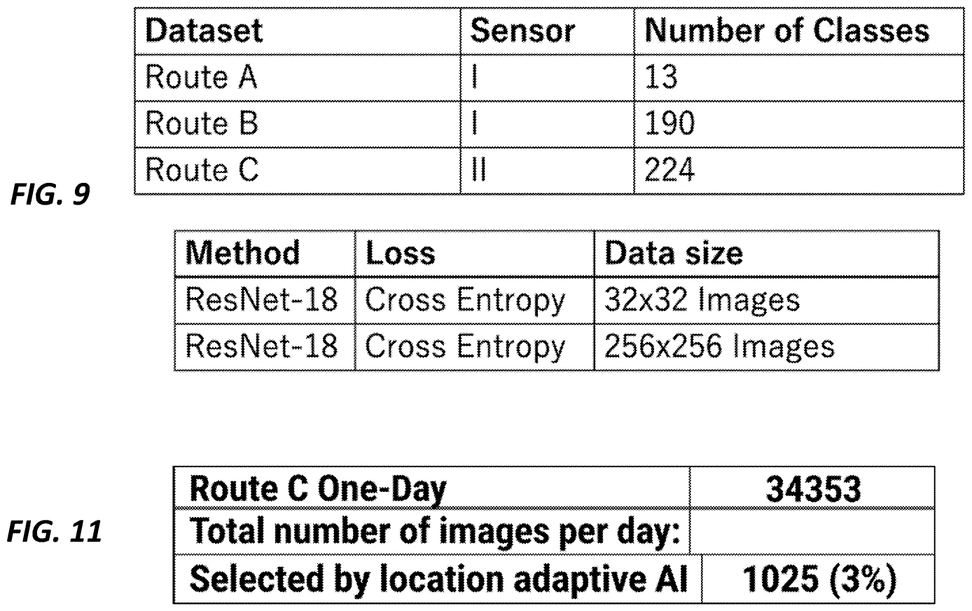

FIG. 10 shows an illustrative alignment of representation and empirical effectiveness of the M-2 projection head according to aspects of the present disclosure.

After the self-training on small sized images of 32×32, the model can classify location among 190 classes with an accuracy of 79.53%. In FIG. 10, the resulting feature is useful for the downstream anomaly classification task. We consider linear probing (Logistic regression), K nearest neighbor (KNN, K=5), and nearest subspace classification (PCA or tSVD with d=30) as benchmark. As can be seen, the classification accuracy reaches over 95%.

The design of projection head can be evidenced by comparing the first row and second row of results in FIG. 10. The features before projection head can better resolve learning conflicts between the two learning objectives. As can be seen from the learning curves, in the beginning epochs, the classification accuracy improves with the model's ability of distinguishing locations. As the model being more and more specialized into location classification, the classification accuracy drops in the later epochs. However, the embedding before projection head still can preserve it over 95.5% percent, the embedding after projection can only preserve it about 90%.

The representation learned by LAAD supports cross-domain generalization. The last row of FIG. 10 shows experiment conducted on images of 256×256, with representation learned on data from route C with 224 classes, and the anomaly classification is tested on data collected from route A and B with different type of DAS sensor. As can be seen, both the location and anomaly classification accuracies reach over 97.5% across all baselines. Our model can be used for reducing the cost of data annotation since most of the patches can be screened out by LAAD. As a result, only a small portion of image patches (about 3%) require human examination

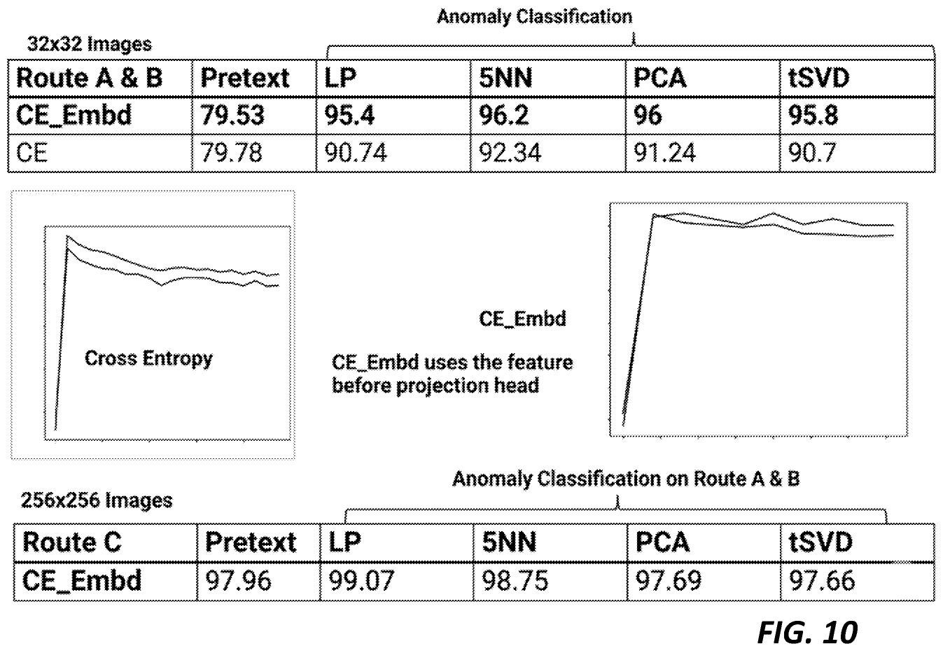

FIG. 11 shows an illustrative dataset used to conduct in-depth ablation studies on the model design according to aspects of the present disclosure. As may be understood, the burden of data annotation may be reduced by 97%.

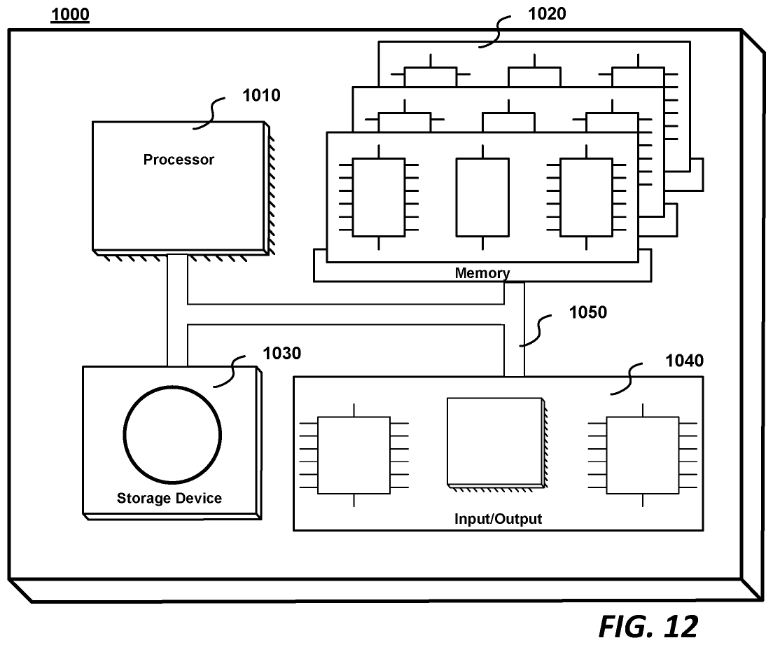

FIG. 12 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 1000 as stored program control instructions.

Computer system 1000 includes processor 1010, memory 1020, storage device 1030, and input/output structure 1040. One or more input/output devices may include a display 1045. One or more busses 1050 typically interconnect the components, 1010, 1020, 1030, and 1040. Processor 1010 may be a single or multi core. Additionally, the system may include accelerators etc., further comprising the system on a chip.

Processor 1010 executes instructions in which embodiments of the present disclosure may comprise steps described in one or more of the Drawing figures. Such instructions may be stored in memory 1020 or storage device 1030. Data and/or information may be received and output using one or more input/output devices.

Memory 1020 may store data and may be a computer-readable medium, such as volatile or non-volatile memory. Storage device 1030 may provide storage for system 1000 including for example, the previously described methods. In various aspects, storage device 1030 may be a flash memory device, a disk drive, an optical disk device, or a tape device employing magnetic, optical, or other recording technologies.

Input/output structures 1040 may provide input/output operations for system 1000.

At this point, those skilled in the art will understand and appreciate that we introduce a Deep Phase-Magnitude Network (DFMN) and point out that combining the filtering in time domain and frequency domain can significantly enhance the classification accuracy and improve the domain generalization ability. We divide the raw fiber sensing data into magnitude response and phase response for parallel feature representation learning. Furthermore, we propose a Phase Frequency Learnable Filter (PFLF) specifically designed for phase component learning, which effectively determines the frequency components crucial for enhancing rain detection accuracy. In the end, we formulate the phase-magnitude channel within a dual-path network and subsequently fuse the features for a comprehensive analysis. Extensive experiments and ablation studies demonstrate the effectiveness of our proposed method.

While we have presented our inventive concepts and description using specific examples, our invention is not so limited. Accordingly, the scope of our invention should be considered in view of the following claims.

1. A method for locally adaptive anomaly detection in a distributed fiber optic sensing (DFOS) system, comprising:
segmenting a fiber optic route into a plurality of locations;
collecting ambient sensing data from the fiber optic route to generate a plurality of data patches;
performing unsupervised self-training of an encoder model to predict a location index for each data patch;
extracting domain-specific features from the data patches using the trained encoder model;
training a classification model for a downstream sensing task based on the extracted domain-specific features and a labeled dataset; and
identifying an anomaly during inference when a predicted location index of a real-time data patch differs from a known ground truth location index of the real-time data patch.

2. The method of claim 1, wherein the unsupervised self-training utilizes a projection head to map high-dimensional embeddings to location prediction logits.

3. The method of claim 2, wherein the projection head is configured to resolve learning conflicts between the location prediction objective and the downstream sensing task objective.

4. The method of claim 1, wherein the identification of an anomaly is conditional based on characteristic vibration patterns associated with the history of the ground truth location.

5. The method of claim 1, wherein the DFOS system includes at least one of a Distributed Acoustic Sensing (DAS) interrogator, a Distributed Vibration Sensing (DVS) interrogator, or a Distributed Temperature Sensing (DTS) interrogator.

6. The method of claim 1, wherein the downstream sensing task includes at least one of cable cut prevention, manhole localization, intrusion detection, or traffic accident detection.

7. The method of claim 1, further comprising performing ensemble learning via majority voting of predicted labels from a plurality of encoder models.

8. The method of claim 1, wherein collecting ambient sensing data includes excluding data collected during time periods with low environmental activity to ensure discriminative patterns are present in the data patches.

9. The method of claim 1, wherein the data patches are normalized using quantile clamping and integer quantization.

10. The method of claim 1, wherein the encoder model is a deep neural network comprising a ResNet architecture.

11. A system for locally adaptive anomaly detection in a fiber optic network, comprising:
a fiber optic interrogator coupled to a fiber cable; and
a processor and memory configured to:
segment the fiber cable into location indices;
train an encoder to predict the location indices using unlabeled ambient data collected from the fiber cable;
generate domain-specific representations of the ambient data;
train a classification head using the domain-specific representations and a labeled dataset; and
flag an anomaly if a forward-pass of a real-time data patch through the encoder results in a predicted location index that does not match a known location of the real-time data patch.

12. The system of claim 11, wherein the encoder remains frozen during the training of the classification head.

13. The system of claim 11, wherein the system is configured to screen a plurality of image patches and select a subset for human annotation, wherein the subset is less than 5% of the plurality of image patches.

14. The system of claim 11, wherein the processor is configured to re-train the encoder automatically if a physical change in the fiber cable length is detected.

15. The system of claim 11, wherein the domain-specific representations are extracted before a projection head in the encoder.

16. The system of claim 11, wherein the classification head provides predicted class labels for flagged anomalies for real-time alert reporting.

17. The system of claim 11, wherein the interrogator utilizes Rayleigh backscattering for acoustic detection.

18. A non-transitory computer-readable medium containing instructions that, when executed by a processor, perform a method comprising:
obtaining ambient sensing data from a fiber optic route;
dividing the data into patches associated with specific locations on the route;
training a neural network to identify the specific locations using the patches as a self-supervised task;
fine-tuning a classification head for an anomaly detection task using features learned during the self-supervised task; and
detecting an anomaly when the neural network misidentifies the location of a patch.

19. The medium of claim 18, further comprising applying a majority voting scheme across K copies of the neural network.

20. The medium of claim 18, wherein the anomaly detection task is trained without using labeled anomaly data.
